(19) United States
(12) Patent Application Publication
(10) Pub. No.: US 2018/0338431 A1
(43) Pub. Date: Nov. 29, 2018

(54) COLLATED GROUND STAPLES

(71) Applicant: Wayne Morgan, Soquel, CA (US)

(72) Inventor: Wayne Morgan, Soquel, CA (US)

(21) Appl. No.: 15/607,204

(22) Filed: May 26, 2017

(51) Int. Cl. A01G 13/02; E02B 3/14; A01G 1/08; F16B 15/00

(52) U.S. Cl. CPC A01G 13/0256; E02B 3/14; E02B 3/04; F16B 15/0015; A01G 1/08

(57) ABSTRACT

A stick of staples comprising a plurality of staples stacked against each other and oriented in the same direction, each of the plurality of staples comprising a first prong which is attached to a second prong by a bridge. A first adhesive sheet affixed to only the first prong of each of the plurality of staples.

### BACKGROUND

A constant challenge in the world of landscaping and gardening is to protect valuable soil, plants, structures and other developments from the detrimental effects of erosion, a. particular threat in banked areas. A related challenge is to protect plants against damage by foragers (gophers, moles, ground squirrels, etc.). Another related aim is to block the growth of undesirable weeds.

Among the existing attempts to solve these problems is to secure sheets of meshed material—made of wire, jute or other materials—either under or over (or sometimes both) the area to be planted. In other applications, the landscaper places dome-topped structures, often fabricated from wire mesh, and in a range of sizes, over the plants in question, then secures the bottom edges of such articles to the ground.

The most common method of affixing the materials noted above is to drive into the soil sharp-tipped, elongated U-shape staple pins (hereinafter “staple(s)” and/or “pin(s)”). The prongs of the staples normally straddle or perforate some portion of the material to be secured. The staples are usually made of metal. They are known by a number of descriptive names: “jute pins.” “landscape staples,” “fabric staples,” “fabric pins,” “ground staples,” “anchor pins,” “sod staples,” “ground anchors,” “grapas” (Spanish), etc. Although sizes can vary, the most typical range of measure is approximately ¾″ to 1¼″ in width and approximately 6″ to 12″ in length. The use of these pins is so ubiquitous that the staples are sometimes collectively referred to as “the landscaper's nail.”

Although the attachment method outlined above is robust and effective, the present design of the staples themselves leaves unsolved problems. An overarching concern is the difficulty of manual control over the staples, because labor cost and productivity are major elements in successful landscaping ventures. Generally stated, the present methods of manual control over the staples are suboptimal, and thus users waste much time, raising the labor cost component of landscaping projects, all the more so for projects where the number of pins to be affixed is in the hundreds if not thousands, as is commonly the case. More specifically, once staples are fully or even partially emptied from their packaging boxes, they tend to get crossed up and entangled. Some users then must spend time disentangling them in order to hang and align them along a waist rope or belt. Other users place handfuls of pins in pouches, where they often become increasingly jumbled and difficult to extract in an orderly fashion, occasionally resulting in hand wounds. In high volume applications, users inevitably drop and lose some number of the staples, resulting in wastage and possible punctures to tires, materials, and hands and feet.

As described in detail in the sections below, the invention claimed herein addresses these and other problems.

### SUMMARY OF THE INVENTION

In some embodiments, the invention is a stick of staples comprising a plurality of individual staples stacked adjacent to each other and oriented in the same direction. Each of the plurality of staples comprises a first prong having a length and which is connected to a second prong by a bridge. A first adhesive material may be affixed to only the first prong of each of the plurality of staples, the first adhesive material forming a connector between each adjacent staple. In some embodiments, the first adhesive material is affixed within only a lower one half of the length of the first prong of each of the plurality of staples. In other embodiments, the first adhesive material may be affixed within only a lower one quarter of the length of the first prong of each of the plurality of staples. In some embodiments, the first adhesive material comprises a backing applied to a flexible sheet. Under this embodiment, the flexible sheet may be selected from one of a polymer, an organic fabric, and a metal. The metal may be selected from one of aluminum and copper.

In some embodiments, the flexible sheet may be affixed to only an external surface of the first prong. In other embodiments, the flexible sheet may be affixed to both an external surface of the first prong and to an internal surface of the first prong. Under this embodiment the flexible sheet may be folded upon itself to create a downward extending portion and an upward extending portion that together form a tab that extends below a bottom point of the first prong such that the first adhesive material on the downwardly extending portion attaches directly to the first adhesive material on the upwardly extending portion.

In some embodiments, the stick of staples further includes a second adhesive material affixed to each adjacent staple only within an upper one half portion of each of the plurality of staples, the second adhesive material forming a connector between each adjacent staple. Under this embodiment, the second adhesive material may be affixed to the bridge of each of the plurality of staples. In other embodiments, second adhesive material may be affixed to only one prong of each of the plurality of staples. Under this embodiment, the only one prong of each of the plurality of staples may be the second prong. Thus, as the second adhesive material may be attached to the second prong, and the first adhesive material may be attached to the first prong, it will be appreciated that adhesive material attached on each of the prongs provides a more stable stick of staples for the artisan to use in a rough gardening or agricultural environment. In some embodiments, the second adhesive material may comprise a backing to a second flexible sheet, and wherein the second flexible sheet is folded upon itself to create an outwardly extending portion and an inwardly extending portion that together form a tab, such that the second adhesive material on the outwardly extending portion attaches directly to the second adhesive material on the inwardly extending portion.

In another embodiment, the invention is a stick of staples comprising a plurality of staples stacked adjacent each other and oriented in the same direction, each of the plurality of staples comprising a first prong having a length and which is connected to a second prong by a bridge. A first adhesive material is affixed to an upper one half portion of each of the plurality of staples. The first adhesive material may comprise a backing to a first flexible sheet, such that the first flexible sheet may be folded upon itself to create an outwardly extending portion and an inwardly extending portion that together form a tab, such that the first adhesive material on the outwardly extending portion attaches directly to the first adhesive material on the inwardly extending portion. In some embodiments, the flexible sheet may be selected from one of a polymer, an organic fabric, and a metal. In embodiments, the metal is selected from one of aluminum and copper. In some embodiments, the invention may further include a second adhesive material affixed to only the first prong of each of the plurality of staples. In some embodiments, the second adhesive material is affixed within only a lower one half of the length of the first prong of each of the plurality of staples. In further embodiments, the second adhesive material may be affixed within only a lower one quarter of the length of the first prong of each of the plurality of staples.

In another embodiment, the invention is a method of controlling a plurality of staples stacked adjacent each other. The method comprises tearing away from each of the plurality of staples a first adhesive backed sheet that is attached to each of the plurality of staples; further, sequentially pulling away each of the plurality of staples from a second adhesive backed sheet that is attached to each of the plurality of staples. In some embodiments, tearing away a first adhesive backed sheet includes tearing away the first adhesive backed sheet from an upper one half portion of the plurality of staples. In other embodiments, the step of sequentially pulling away each of the plurality of staples may include sequentially pulling away each of the plurality of staples from a second adhesive backed sheet that is attached to a lower one half portion of the plurality of staples. In additional embodiments, sequentially pulling away each of the plurality of staples may include sequentially pulling away each of the plurality of staples from a second adhesive backed sheet that is attached to a lower one quarter portion of the plurality of staples.

These, and other advantages of the invention, will become apparent when viewed in light of the drawings and the detailed description of some of the embodiments.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages:

FIG. 1 is a view of a ground staple typically known and used in the landscaping industry;

FIG. 2 is a perspective view, from above and sideways, of a collated stick of staples showing features of the invention;

FIG. 3 is an elevational view of a detail portion of the stick of staples in FIG. 2;

FIG. 3A is a partial sectional view of a collated stick of staples, taken substantially along line R-R in FIG. 3.

FIG. 3B is another embodiment of the shown. FIG. 3A.

FIG. 4 is a detail portion of the stick of staples in FIG. 2, showing the stick in perspective from the top;

FIG. 4A is a partial sectional view of collated stick of staples, taken substantially along the line T-T in FIG. 4.

FIG. 4B is a partial sectional view of a collated stick of staples in another embodiment to that shown in FIGS. 2 and 4.

FIG. 5 is a perspective view of the stick of staples in FIG. 2 being used, specifically during removal of a stabilizing adhesive upper sheet;

FIG. 6 is a perspective view of the stick of staples in FIG. 5 being used after a stabilizing adhesive is removed, specifically during distribution while being fanned out in hand of a user, presenting an easy to way remove a staple from the top of the stick.

### DETAILED DESCRIPTION OF SOME EMBODIMENTS

The present invention involves a unique means of securing, organizing and ensuring efficient and safe delivery and use of landscaping staples by end users.

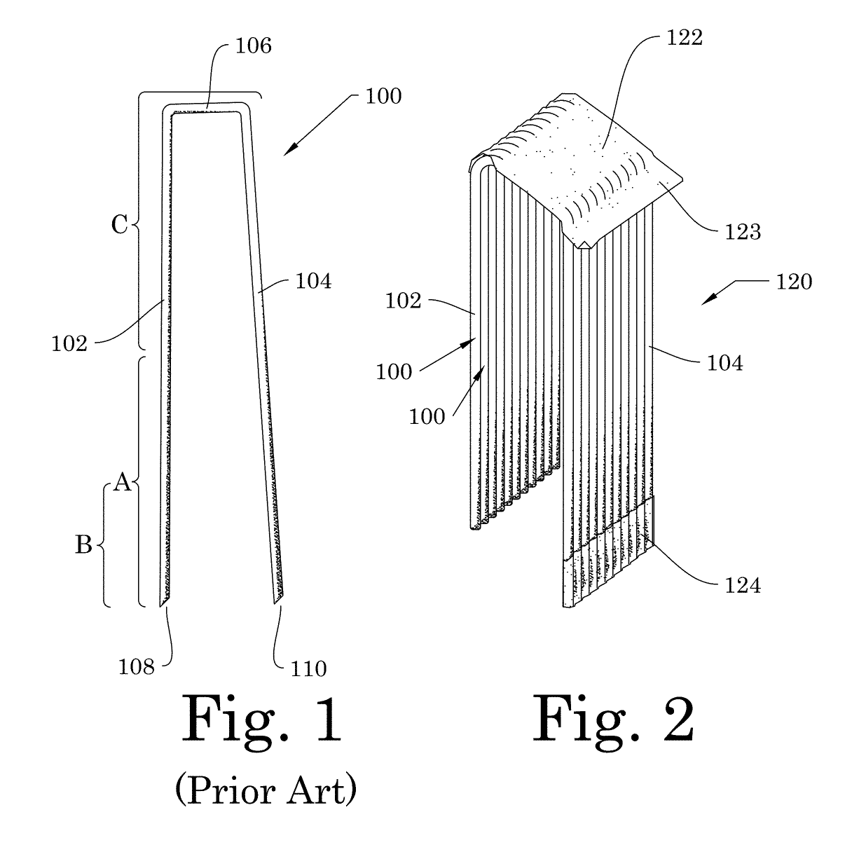

FIG. 1 shows a single “uncollated”) staple 100 of typical form known in the landscaping industry. The staple comprises two elongated prongs 102, 104 extending downwardly and ending in sharp tips 108 and 110 respectively, the prongs being connected at a top end respectively by a short bridge 106 to produce an elongated structure having a generally inverted “U” shape. As used herein, the terms “bottom, lower, etc.” and “top, upper, etc.” will be used to orient an element so that bottom, lower is in a direction of the sharp tips 108, 110 and top, upper is in a direction of the bridge 106. Although sizes can vary, the most typical range of measure is approximately ¾″ to 1¼″ in width and approximately 6″ to 12″ in length. The scope of the invention includes a bridge that may assume different shapes, including a straight shape, a curved shape, and the bridge may be short so that the “U” shape tends towards having a “V” shape.

FIG. 2 is a perspective view of a stick 120 of collated staples 100 according to an embodiment of the invention. In some embodiments, the number of staples in the stick is in the range of 5 to 15 staples.

In some embodiments, the staples in stick 120 may be held in fixed and collated relation to each other by an applied material 122 that is adhesively fixed to an upper portion of each staple 100, within an upper half portion of each staple as exemplified by region “C” shown in FIG. 1. In some embodiments, the applied material may be attached to the bridge 106, as exemplified in FIGS. 2, 4, 4A and 5. In other embodiments, the applied material may be applied to one of the prongs 102 or 104, in the upper half portion of the prong and preferably adjacent to the bridge as shown in FIG. 4B.

It is desirable that the structure of the adhesive material resists softening, hardening and distortion under certain field and storage conditions, such as extended exposure to the sun or other environments varying in temperature and/or humidity, and rough handling. Thus, in one preferred embodiment, the applied adhesive material includes a thin aluminum foil that may be commercially obtained and having a contact adhesive pre-applied to one surface of the foil or sheet. Such foil is made by a number at manufacturers, including 3M Company and Nashua Corporation, and is readily available commercially. Alternatively, a thin copper or metal foil may be used, obtainable from the same or similar sources. However, in other embodiments, the foil or sheet may be formed from a synthetic, polymer, or organic substance. This foil or sheet may be conveniently pressed at least partially into the spaces between the staples to increase the contact surface area between sheet and staples, thereby strengthening the integrity of the stick during manipulation. Other embodiments of the invention may realize collative adhesion via alternative materials and application methods, such as (but limited to) a plastic/rubber dip, or applied glue without a backing sheet, or via other types of adhesive fabric sheet such as polymer or an organic sheet with or without preheating.

In some embodiments in which a sheet of material is used such as an adhesive sheet, the adhesive sheet applied to the top beams 106 of the staples in the stick 1.20 may include a portion 123 of the sheeting that extends outwardly away from the staple, and which may be folded over upon itself in two portions 122a and 122b so that an adhesive side 130 of one portion 122a attaches to an adhesive 130 side of the other portion 122b to provide a conjoined tab 123 that has no adhesive on an exposed surface. This may be envisaged with reference to FIGS. 2, 4, and 4A. This absence of exposed adhesive on this tab creates a useful grab element by which a user may pull on the sheet 122 with his/her fingers in order to remove the sheet from the bridges 106 during use of the invention, as is described in more detail below.

In some embodiments in which an upper sheet is applied to a prong 104, the same comments are made with regard to FIG. 4B, in which the relevant identification numerals are modified by a double prime. The comments herein are mainly directed to the first embodiment, but apply equally to the second embodiment.

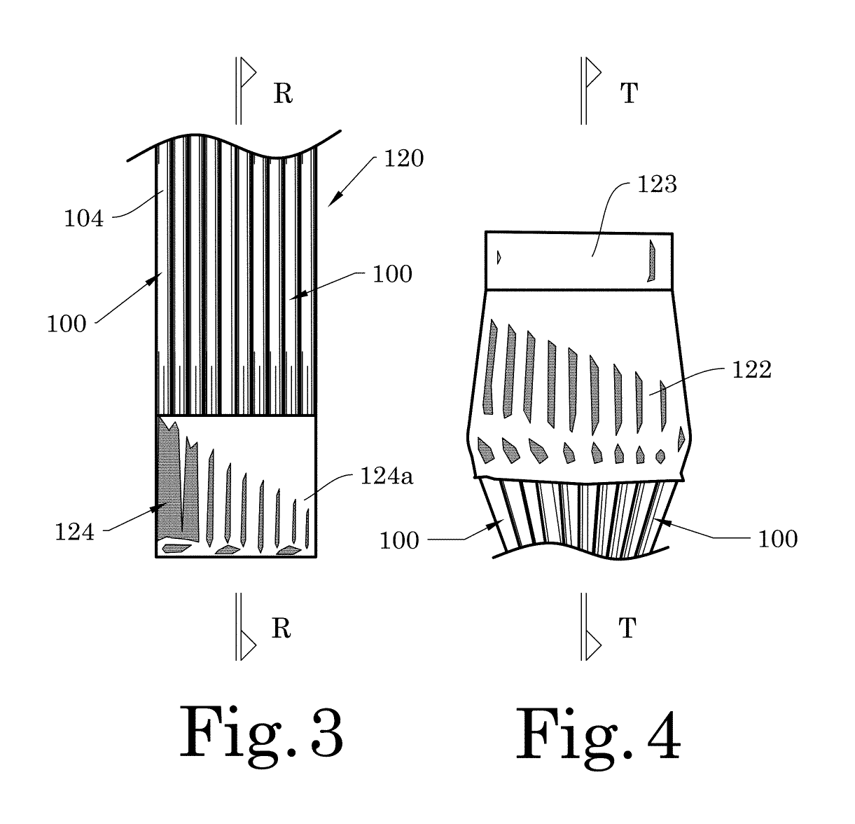

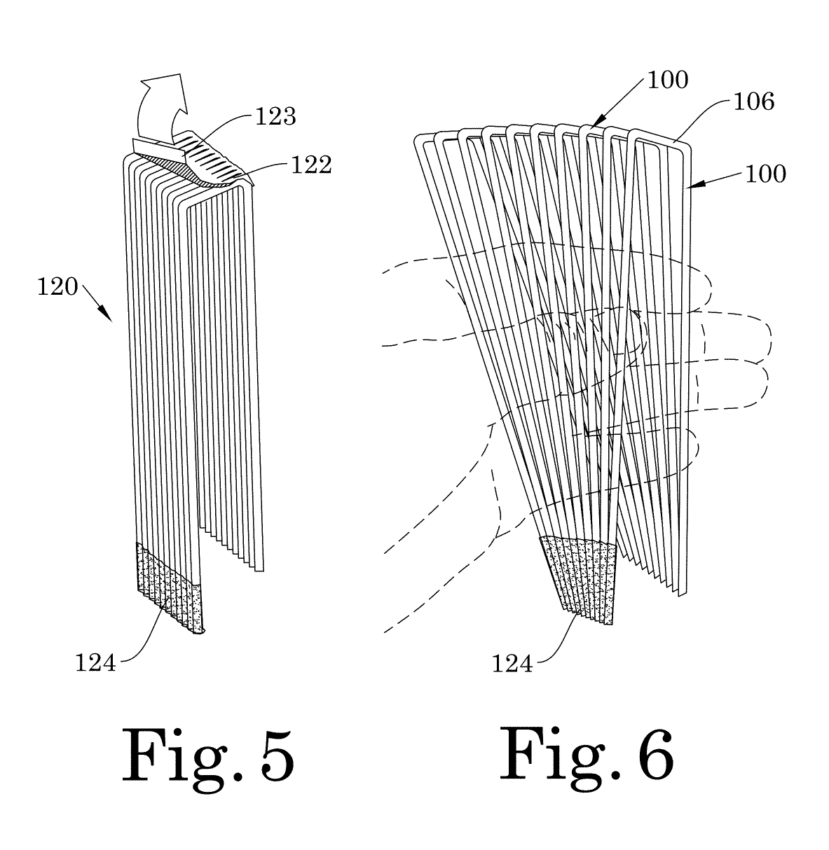

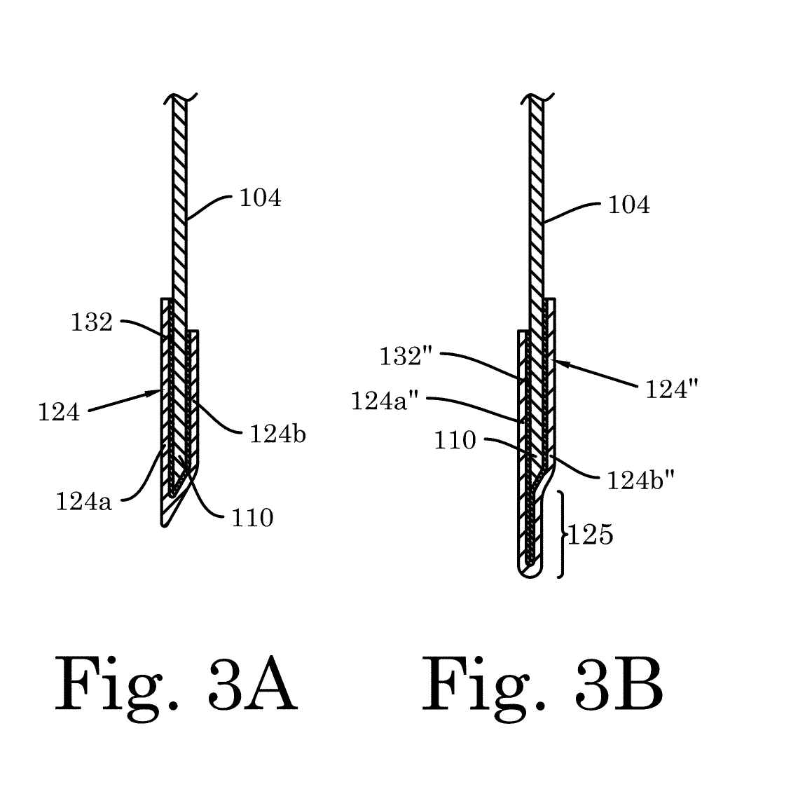

With reference to FIGS. 3A and 3B, in some embodiments, the staples in the stick 120 of collated staples may be further held in fixed relation to each other by a lower adhesive material such as an adhesive alone or an adhesive 132 backed sheet 124, which is attached to only one prong of the two prongs of each staple 100 in the stick 120. In the example shown in the figures, the lower sheet 124 is attached to prong 104, but not to the other prong 102. In some preferred embodiments, the lower sheet 124 is attached to a portion of the prong 104 that corresponds with only the lower half portion (exemplified as bracketed portion “A” in FIG. 1) of the prong 102 or 104; in highly preferred embodiments, the lower sheet 124 is attached to a portion of the prong 102 or 104 that corresponds with only the lower quarter portion (exemplified as bracketed portion “B” in FIG. 1) of the prong. As in the case of the upper adhesive material, further embodiments may realize collative adhesion via alternative materials and application methods, such as (but limited to) a plastic/rubber dip, or applied glue without a backing sheet, or via other types of adhesive fabric sheet such as polymer or an organic sheet with or without preheating.

Where a sheet is used with adhesive 132 backing, as exemplified in FIG. 3A, the lower sheet 124 may be folded over the sharp points 110 of the prong 104, so that an external portion 124a adheres to an external surface (as used herein, “external” is external to the “U” shape of the staple 100) of each prong through adhesive 132, and so that an internal portion 124b adheres to an internal surface (as used herein, “internal” is internal to the “U” shape of the staple 100) of each prong 104. Thus, with both internal and external surfaces of prongs 104 of each staple being so enclosed at the tip 110, the lower sheet 124 secures the staples in the stick against undesirably lenient movement relative to each other and ensures that all staples remain oriented in the same direction, allowing a user to grab and handle a stick 120 efficiently and safely, as shown in FIG. 6.

In some embodiments, exemplified in FIG. 3B, an external portion 124a″ of lower sheet 124 may extend beyond the tip 110 of the prongs 104, before being folded back as an internal portion 124b″. Here, the sheet is folded upon itself to create an outwardly extending portion 124a″ and an inwardly extending portion 124b″ that together form a downwardly extending tab 125, such that the adhesive material 132″ on the outwardly extending portion attaches directly to the adhesive material 132″ on the inwardly extending portion. The resulting element prevents the sharp points 110 from perforating adhesive sheet 124″ during manipulation in use. Tab 125 also helps to retain all staples remaining in stick 120 as the user selects and withdraws staples 100 in the course of landscaping operations; repeated experimentation has showed that in the absence of tab 125, the adhesive integrity of the interior portion 124b of sheet 124 reduces as the user reaches the last the 3-4 pins, whereas the inclusion of tab 125 greatly mitigates such problem.

The lower sheet 124 as described has features that will advantageously facilitate a useful function during distribution of the staples from the stick, as described more fully below.

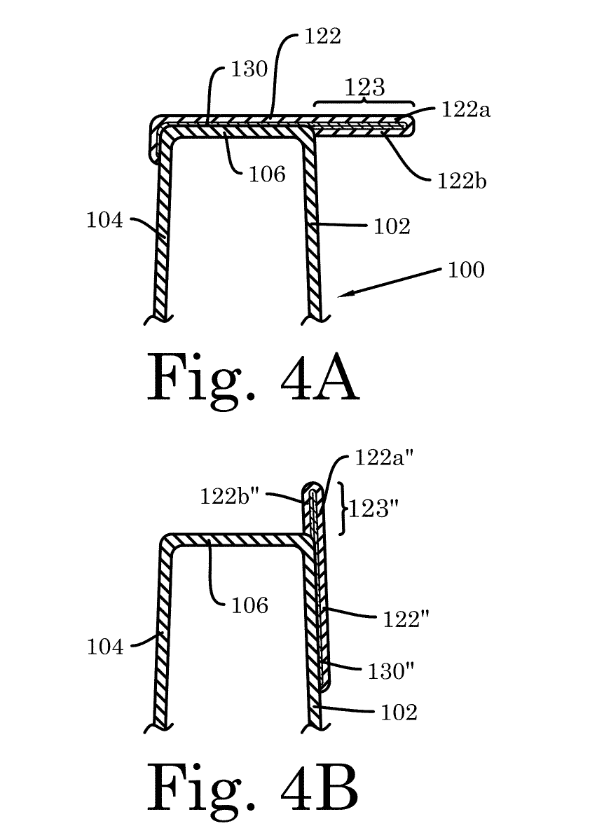

In use, the stick 120 of staples may be applied as follows. As exemplified in FIG. 5, where an upper sheet 122 is present, a user may peel it off the collated staples by grasping the tab 123 between the thumb and forefinger, and pulled vertically and back in the direction shown by the arrow. Extensive experimentation has shown that the upper sheet 122 can play an important role in stabilizing the staples 100 in a stick 120 during delivery, storage, distribution and initial manipulation, before the end use of the staples. Preferably, the upper sheet is placed on a bridge 106, or on an upper half portion (shown by bracketed portion “C” in FIG. 1) of only one prong 102. Preferably, if placed on a prong, then the prong that is opposite to the prong that is also stabilized by the lower tape 124 may be selected for the upper sheet in order to provide enhanced stability during manipulation of the stick 120 before it is used in the field, because this arrangement better secures the staples on both sides.

Once the upper sheet 122 is completely removed the user is able to use only one hand to fan out the staples 100 much like a hand of cards (the left hand is exemplified in FIG. 6). The other hand is thus free to engage in other manipulations such as placement and hammering. The lower sheet 124 is positioned preferably on the lower end of only one prong , thereby allowing the staples to rotate about a common lower point. The effect is that the bridge 106 of each staple may be conveniently separated from a neighboring bridge, as exemplified in FIG. 6. This allows the user to use his/her free hand to remove one staple at a time from its collated position at the top of the stack, by tearing such staple off the point of connection to the lower sheet 124. The thickness of the lower sheet and/or its adhesive strength are selected to permit the staple to tear off or otherwise release the staple with relative ease, while leaving the remaining staples connected to each other. Thus, if the stick is only partially consumed, the user may return the balance of the stick to a storage container without the staples becoming entangled with each other. Another advantage is that collated staple sticks 120 are amenable to placement in a user's pouch or bag, and also to hang vertically in a straddling position on belts, waist ropes, pouches or specially designed holding cups. In this way, the user can orient the unwrapped pointed end of sticks 120 to the inside of the given holding apparatus, thus again maximizing safety, efficiency and economy.

Relatedly, by holding a fanned collated stick 120 in hand, the user lessens the frequency of dipping back to the holding pouch, cup or other container. Staples 100 remain neatly together and neatly oriented, whether the stick 120 is in hand or arranged in or on belts, pouches or the like.

Thus, there is herein described a system and method for neatly, quickly and safely unboxing, organizing, and feeding multiple units of staple pins as the user needs them. A convenient number of the pins are collated in sticks, with all units in each stick oriented in the same direction. The nature of the adhesive material, and the pattern and mode of its placement, together provide an appropriately robust degree of resistance, tensility and torque for fanning out and removing the staple pins one-by-one without disturbing the integrity and order of the remaining portion of the stick, and without the need to reach back constantly into a belt or pouch to obtain an additional staple pin. In this manner time waste, materials loss and injury risk are minimized. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

I claim:

1. A stick of staples comprising:
a plurality of staples stacked adjacent to each other and oriented in the same direction, each of the plurality of staples comprising a first prong having a length and which is connected to a second prong by a bridge; and
a first adhesive material affixed to only the first prong of each of the plurality of staples, the first adhesive material forming a connector between each adjacent staple.

2. The stick of staples of claim 1, wherein the first adhesive material is affixed within only a lower one half of the length of the first prong of each of the plurality of staples.

3. The stick of staples of claim 2, wherein the first adhesive material is affixed within only a lower one quarter of the length of the first prong of each of the plurality of staples.

4. The stick of staples of claim 1, wherein the first adhesive material comprises a backing applied to a flexible sheet.

5. The stick of staples of claim 4, wherein the flexible sheet is selected from one of a polymer, an organic fabric, and a metal.

6. The stick of staples of claim 5, wherein the metal is selected from one of aluminum and copper.

7. The stick of staples of claim 4, wherein the flexible sheet is affixed to only an external surface of the first prong.

8. The stick of staples of claim 4, wherein the flexible sheet is affixed to both an external surface of the first prong and to an internal surface of the first prong.

9. The stick of staples of claim 4, wherein the flexible sheet is folded upon itself to create a downward extending portion and an upward extending portion that together form a tab that extends below a bottom point of the first prong such that the first adhesive material on the downwardly extending portion attaches directly to the first adhesive material on the upwardly extending portion.

10. The stick of staples of claim 1, further including a second adhesive material affixed to each adjacent staple only within an upper one half portion of each of the plurality of staples, the second adhesive material forming a connector between each adjacent staple.

11. The stick of staples of claim 10, wherein the second adhesive material is affixed to the bridge of each of the plurality of staples.

12. The stick of staples of claim 10, wherein the second adhesive material is affixed to only one prong of each of the plurality of staples.

13. The stick of staples of claim 12, wherein the only one prong of each of the plurality of staples is the second prong.

14. The stick of staples of claim 10, wherein the second adhesive material comprises a backing to a second flexible sheet, and wherein the second flexible sheet is folded upon itself to create an outwardly extending portion and an inwardly extending portion that together form a tab, such that the second adhesive material on the outwardly extending portion attaches directly to the second adhesive material on the inwardly extending portion.

15. A stick of staples comprising:
a plurality of staples stacked adjacent each other and oriented in the same direction, each of the plurality of staples comprising a first prong having a length and which is connected to a second prong by a bridge;
a first adhesive material removably affixed to an upper one half portion of each of the plurality of staples;
wherein the first adhesive material comprises a backing to a first flexible sheet, and wherein the first flexible sheet is folded upon itself to create an outwardly extending portion and an inwardly extending portion that together form a tab, such that the first adhesive material on the outwardly extending portion attaches directly to the first adhesive material on the inwardly extending portion.

16. The stick of staples of claim 15, wherein the flexible sheet is selected from one of a polymer, an organic fabric, and a metal.

17. The stick of staples of claim 16, wherein the metal is selected from one of aluminum and copper.

18. The stick of staples of claim 15, further including a second adhesive material affixed to only the first prong of each of the plurality of staples.

19. The stick of staples of claim 18, wherein the second adhesive material is affixed within only a lower one half of the length of the first prong of each of the plurality of staples.

20. The stick of staples of claim 19, wherein the second adhesive material is affixed within only a lower one quarter of the length of the first prong of each of the plurality of staples.

21. A method of controlling a plurality of staples stacked adjacent each other, the method comprising:
tearing away from each of the plurality of staples a first adhesive backed sheet that is attached to each of the plurality of staples;
sequentially pulling away each of the plurality of staples from a second adhesive backed sheet that is attached to each of the plurality of staples.

22. The method of claim 21, wherein tearing away a first adhesive backed sheet includes tearing away the first adhesive backed sheet from an upper one half portion of the plurality of staples.

23. The method of claim 21, wherein sequentially pulling away each of the plurality of staples includes sequentially pulling away each of the plurality of staples from a second adhesive backed sheet that is attached to a lower one half portion of the plurality of staples.

24. The method of claim 21, wherein sequentially pulling away each of the plurality of staples includes sequentially pulling away each of the plurality of staples from a second adhesive backed sheet that is attached to a lower one quarter portion of the plurality of staples.
